(19) United States
(12) Patent Application Publication
(10) Pub. No.: US 2016/0072336 A1
(43) Pub. Date: Mar. 10, 2016

(54) POWER TRANSMITTER, POWER SUPPLY DEVICE, POWER CONSUMPTION DEVICE, POWER SUPPLY SYSTEM AND METHOD FOR PRODUCING POWER TRANSMITTER

(71) Applicant: SHOWA DENKO K.K., Minato-ku, Tokyo (JP)

(72) Inventors: Yasuaki TAMINO, Tokyo (JP); Ayako NISHIOKA, Tokyo (JP); Hiroshi KONUMA, Tokyo (JP); Mitsuhiro IMAIZUMI, Tokyo (JP); Koji TOKITA, Tokyo (JP)

(73) Assignee: SHOWA DENKO K.K., Minato-ku, Tokyo (JP)

(21) Appl. No.: 14/784,537

(22) PCT Filed: Jun. 26, 2014
(86) PCT No.: PCT/JP2014/067033

§ 371 Date: Oct. 14, 2015

(30) Foreign Application Priority Data
Jun. 27, 2013 (JP) 2013-135309

(51) Int. Cl. H02J 7/02; H02J 7/00

(52) U.S. Cl. CPC H02J 7/025; H02J 7/0042

(57) ABSTRACT

The power transmitter used for wireless power supply, includes a structure in which a sheet of a conductive body forming plural layers stacked in a thickness direction in a dielectric body. The dielectric body is also located between the plural layers, and different layers of the sheet of the conductive body are electrically connected. The power transmitter easily ensures the insulation properties at a position where the electrode is disposed while improving the power transmission efficiency in the case of the wireless power supply with the electric field coupling system.

### TECHNICAL FIELD

The present invention relates to a power transmitter used for wireless power supply with an electric field coupling system, for example.

### BACKGROUND ART

A technique for wireless power supply in which power is transmitted to power consumption devices such as portable devices with no cable has become popular. Various systems have been suggested for the wireless power supply, such as an electromagnetic induction system, an electric field coupling system, and a magnetic field resonance system.

In a method using the electric field coupling system among them, for example, an electrode provided in a power supply device and an electrode provided in a power consumption device are caused to face each other, an alternating voltage is applied to the electrode in the power supply device to generate electrostatic induction between the electrodes, and thus alternating-current power is transmitted using the electrostatic induction.

Patent document 1 discloses a power supply system for supplying power to a predetermined load from a fixed body arranged in a power supply region, via a movable body arranged in a power receiving region. The fixed body includes a first power transmission electrode and a second power transmission electrode arranged at positions in the vicinity of a boundary surface between the power supply region and the power receiving region. The movable body includes a first power reception electrode and a second power reception electrode arranged at positions in the vicinity of the boundary surface. Each of the first power reception electrode and the second power reception electrode is arranged to face corresponding one of the first power transmission electrode and the second power transmission electrode, and not to be in contact with the corresponding one of the first power transmission electrode and the second power transmission electrode.

Further, patent document 2 discloses a device composed of energy production and consumption devices situated a short distance apart, it uses neither the propagation of electromagnetic waves nor induction, and cannot be reduced to a simple arrangement of electrical capacitors. The device is modeled in the form of an interaction between oscillating asymmetric electric dipoles, consisting of a high-frequency high-voltage generator or of a high-frequency high-voltage load placed between two electrodes. The dipoles exert a partial influence on one another.

Furthermore, patent document 3 discloses an electrode structure for non-contact power supply system which performs a non-contact power supply to a power reception body from a power supply body. The electrode structure in which a coupling capacitor is formed by arranging a power transmission electrode of a fixed body and a power reception electrode of a movable body so that they face each other includes a reduction inhibiting unit inhibiting reduction of a capacitance of the coupling capacitor caused by a gap between the power transmission electrode and the power reception electrode by reducing the gap with a dielectric layer that is arranged between the power transmission electrode and the power reception electrode and that has higher permittivity than air.

Still furthermore, patent document 4 discloses a method for manufacturing an electrode having ferroelectric layer firmly fixed thereon including: preparing a power transmission electrode having both side surfaces communicating through a penetration hole; arranging a resin in which a ferroelectric particles have been mixed on one of the side surfaces of the power transmission electrode; suctioning part of the resin from the other side surface of the power transmission electrode through the penetration hole of the power transmission electrode while pressurizing the resin from the one side surface of the transmission electrode, extruding the part of the resin from the penetration hole by pressurizing the resin from the one side surface of the transmission electrode, or suctioning the part of the resin from the other side surface of the power transmission electrode through the penetration hole of the power transmission electrode; and solidifying the resin.

Still furthermore, patent document 5 discloses a laminated solid electrolytic capacitor constituted by placing, in a chip, a lamination structure of plural single-plate capacitor elements as a parallel lamination, counter lamination, alternately counter lamination, or close-packed lamination.

Still furthermore, patent document 6 discloses a capacitor including two film-shaped members each of which has one surface having an internal electrode thereon, which has been layered so that surfaces having no internal electrode face each other, and which have had alternately-repeating mountain folds and valley folds. An external electrode is formed on each surface formed by the mountain folds of each of the two film-shaped members.

Still furthermore, patent document 7 discloses a capacitor including an anode foil and a cathode foil, and a separator arranged between the anode foil and the cathode foil. The anode foil, the cathode foil, and the separator are wound around, so that the separator is intervened between the anode foil and the cathode foil. The anode foil has a dielectric oxide film layer, and the separator includes a solid electrolyte and a nonwoven fabric holding the solid electrolyte. The nonwoven fabric included in the separator is a laminated nonwoven fabric having at least two layers of the nonwoven fabric layers, and the laminated nonwoven fabric includes a nonwoven fabric layer (layer I) composed of ultra fine fiber having a fiber diameter of 0.1 to 4 μm, and a nonwoven fabric layer (layer II) composed of a thermoplastic resin fiber having a fiber diameter of 6 to 30 μm.

### CITATION LIST

### Patent Literature

Patent Document 1: Japanese Patent Application Laid-Open Publication No. 2009-89520

Patent Document 2: Japanese Unexamined Patent Application Publication (Translation of PCT Application) No. 2009-531009

Patent Document 3: Japanese Patent Application Laid-Open Publication No. 2011-259649

Patent Document 4: Japanese Patent Application Laid-Open Publication No. 2012-5171

Patent Document 5: Japanese Patent Application Laid-Open Publication No. 2001-230156

Patent Document 6: Japanese Patent Application Laid-Open Publication No. 2004-111588

Patent Document 7: International Publication Brochure No. 2011/021668

### SUMMARY OF INVENTION

### Technical Problem

In the case of the wireless power supply, improvement of power transmission efficiency is required to transmit larger power. In particular, in the case of the wireless power supply with the electric field coupling system, ensuring insulation properties at the section where the electrode is disposed is required because high alternating-current voltage is applied to the electrode.

An object of this invention is to provide a power transmitter, a power supply device and the like, which enable the power transmission efficiency to be improved and the insulation properties at the section where the electrode is disposed to be easily ensured in the wireless power supply with the electric field coupling system.

### Solution to Problem

There is provided a power transmitter of this invention used for wireless power supply, including: a dielectric body; a sheet of a conductive body forming, in the dielectric body, plural layers stacked in a thickness direction; and a structure in which the dielectric body is also located between the plural layers is formed. Different layers of the sheet of the conductive body are electrically connected.

Here, it is preferable to have a structure in which the sheet of the conductive body has been folded in the dielectric body.

Further, it is preferable to have a structure in which a covering sheet has been folded, the covering sheet being formed by putting the sheet of the conductive body and a sheet of the dielectric body together, and layering the sheet of the conductive body and the sheet of the dielectric body.

Furthermore, it is preferable to have any one of a structure in which the covering sheet formed into a rectangle has been alternately mountain-folded and valley-folded from one short side toward the other short side, or a structure in which the one covering sheet formed into a rectangle and the another covering sheet formed into a rectangle have been folded by orthogonally arranging and layering one short side of the one covering sheet and one short side of the another covering sheet, and alternately folding the one covering sheet and the another covering sheet along lines each corresponding to a boundary between an area where the one covering sheet and the another covering sheet are layered and an area where the one covering sheet and the another covering sheet are not layered.

Still furthermore, the wireless power supply may be performed by an electric field coupling system.

Still furthermore, the dielectric body is preferably made of any one of a rubber and a resin, and the conductive body is preferably made of at least one chosen from among metals, conductive oxides, conductive polymers, conductive filler composite rubbers and complexes thereof.

Further, there is provided a power supply device of this invention including: an alternating-current power source generating an alternating-current power; an electrode forming an electric field coupling part for supplying the alternating-current power, by an electric field coupling system, to a power consumption device consuming the alternating-current power generated by the alternating-current power source; and a cover disposed on one side of the electrode, and insulating the electrode, the one side being a side toward the power consumption device. The cover is the aforementioned power transmitter.

Furthermore, there is provided a power consumption device of this invention including: an electrode forming an electric field coupling part for receiving, by an electric field coupling system, an alternating-current power from a power supply device supplying the alternating-current power; a loading unit consuming the alternating-current power received by the electrode; and a cover disposed on one side of the electrode, and insulating the electrode, the one side being a side toward the power supply device. The cover is the aforementioned power transmitter.

Still furthermore, there is provided a power supply system of this invention including: an alternating-current power source generating an alternating-current power; a loading unit consuming the alternating-current power generated by the alternating-current power source; an electric field coupling part comprising a pair of electrodes facing together, and allowing the alternating-current power to pass between the electrodes as the pair using an electric field coupling system; and a cover disposed between the electrodes as the pair, and insulating at least any one of the electrodes as the pair. The cover is the aforementioned power transmitter.

Still furthermore, there is provided a method for producing the power transmitter, the method of this invention including: preparing the covering sheet by putting the sheet of the conductive body and the sheet of the dielectric body together and layering the sheet of the conductive body and the sheet of the dielectric body; and folding the covering sheet that has been prepared.

Here, preparing the covering sheet preferably includes unifying the sheet of the conductive body and the sheet of the dielectric body.

In addition, unifying the sheet of the conductive body and the sheet of the dielectric body is preferably performed by thermally bonding the sheet of the conductive body and the sheet of the dielectric body with pressure, or by adhering the sheet of the conductive body and the sheet of the dielectric body with an adhesive agent.

### Advantageous Effects of Invention

When the power transmitter of the present invention is used in the wireless power supply with the electric field coupling system, the power transmission efficiency can be improved, and a power transmitter, a power supply device and the like, which enable the insulation properties at the section where the electrode is disposed to be easily ensured, can be provided.

### BRIEF DESCRIPTION OF DRAWINGS

FIG. 1 is a view illustrating an example of a power supply system to which the exemplary embodiment is applied.

FIG. 2 is a block diagram showing an example of functional configurations of the power supply table and the portable device in the power supply system.

FIG. 3 is a conceptual diagram showing an operation principle of a series resonance configuration enabling the wireless power supply with the electric field coupling system.

FIG. 4 is a diagram illustrating one example of a circuit conceptual diagram of a parallel resonance configuration.

FIGS. 5A to 5C are diagrams illustrating examples of a covering sheet.

FIGS. 6A to 6C are views illustrating the first example of a method of folding the covering sheet.

FIGS. 7A to 7E are views illustrating the second example of the method of folding the covering sheet.

FIG. 8A is a diagram for describing the capacitance and the insulation properties of the cover in the exemplary embodiment.

FIGS. 8B to 8D are diagrams for describing the capacitances and the insulation properties of covers according to other exemplary embodiments.

FIGS. 9A to 9C show the measured result.

### DESCRIPTION OF EMBODIMENTS

### <Description of Power Supply System>

Hereinafter, detailed description will be given for the exemplary embodiment of this invention with reference to attached drawings.

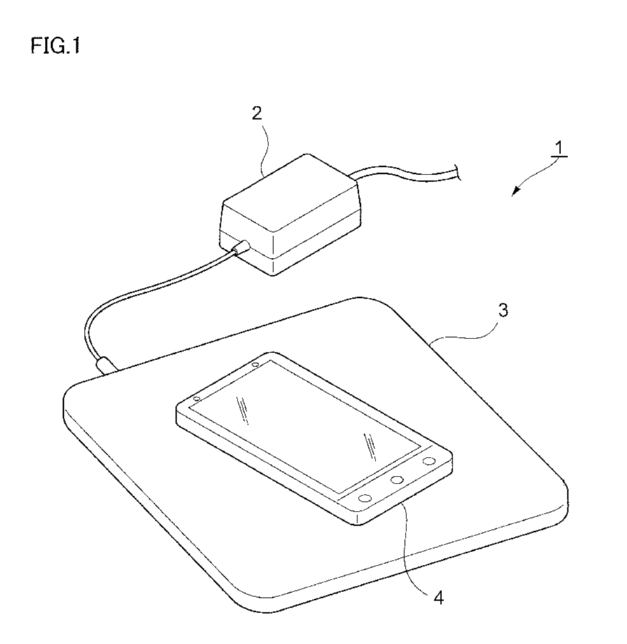

FIG. 1 is a view illustrating an example of a power supply system to which the exemplary embodiment is applied.

A power supply system 1 of the exemplary embodiment includes an alternating current (AC) adapter 2, a power supply table 3 as one example of a power supply device, and a portable device 4 as one example of a power consumption device.

The AC adapter 2 is connected to a commercial power source, power from the commercial power source is input to the AC adapter 2, and the AC adapter 2 outputs appropriate power to the power supply table 3. In this case, the commercial power source has an alternating-current voltage of 100V, for example. The power to be output to the power supply table 3 is, for example, 5 W.

The power supply table 3 is a device for supplying the portable device 4 with power. In the exemplary embodiment, power is wirelessly supplied to the portable device 4 at this time, as the wireless (non-contact) power supply with the electric field coupling system, which will be described later in detail.

The portable device 4 is, for example, a smartphone. However, the portable device 4 is not limited to this, and may be a tablet terminal, a cell phone, a personal computer, a digital camera, a mobile battery, an organic electro-luminescence (EL) lighting, a light-emitting diode (LED) lighting or the like. The portable device 4 is just one example of a power consumption device, and another device consuming power is certainly accepted if supplied power is higher. Examples of another device include a delivery robot, an electric assist bicycle, and an electric vehicle.

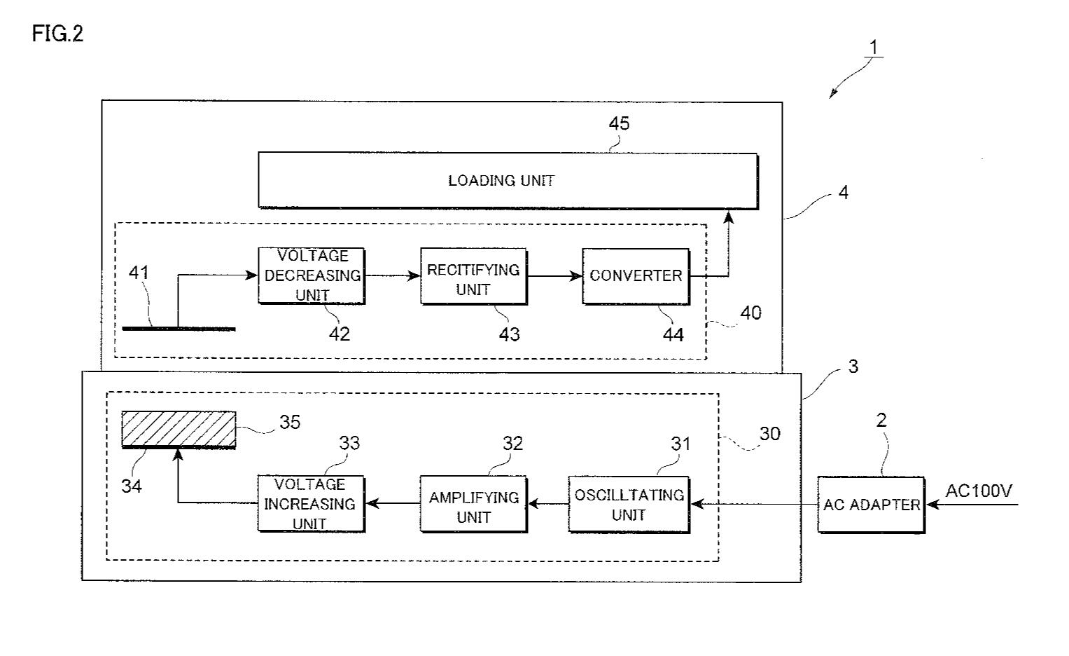

The portable device 4 is merely put on the power supply table 3, and need not be fixed to the power supply table 3. As long as the side where a power receiving module 40 (refer to FIG. 2) to be described later is provided is put toward the power supply table 3 when the portable device 4 is put on the power supply table 3, the position or direction of the portable device 4 on the power supply table 3 is not largely limited in comparison with the case of an electromagnetic induction system which will be described later. When the portable device 4 is put on the power supply table 3 by, for example, a user of the portable device 4, putting the portable device 4 is detected by the power supply table 3 side, and charge thereof automatically starts. Various systems have been suggested as a system configured to detect the portable device 4, and any system can be used.

FIG. 2 is a block diagram showing an example of functional configurations of the power supply table 3 and the portable device 4 in the power supply system 1. Note that FIG. 2 selectively shows units relating to the exemplary embodiment among units having various functions of the power supply table 3 and the portable device 4.

The power supply table 3 includes a power supply module 30. The power supply module 30 includes an oscillating unit 31 that generates high-frequency alternating-current (AC) power, an amplifying unit 32 that amplifies the high-frequency AC power, a voltage increasing unit 33 that increases the voltage of the high-frequency AC power amplified by the amplifying unit 32, an electrode 34 supplying power to the portable device 4 with the electric field coupling system, and a cover 35 that insulates the electrode 34.

Meanwhile, the portable device 4 includes the power receiving module 40. The power receiving module 40 includes an electrode 41 configured to receive the high-frequency AC power with the electric field coupling system, a voltage decreasing unit 42 that decreases the voltage of the high-frequency AC power received by the electrode 41, a rectifying unit 43 that converts the high-frequency AC power into direct-current (DC) power, and a converter 44 that adjusts the voltage of the DC power.

The portable device 4 further includes a loading unit 45 that consumes the AC power received by the electrode 41. The loading unit 45 is a functional unit that works depending on the purpose of use of the portable device 4. For example, in the case where the portable device 4 is a smartphone, the loading unit 45 corresponds to a communication unit having a communication function, a rechargeable battery for operation of the communication unit, a rechargeable battery controller that controls charge to the rechargeable battery, and the like.

In the power supply module 30 of the exemplary embodiment, the power supplied from the AC adapter 2 is converted by the oscillating unit 31 first, to generate high-frequency AC power. That is, the oscillating unit 31 contains an oscillation circuit and the like, and functions as an inverter converting the DC power into the AC power. The frequency of the high-frequency AC power generated at this time is, for example, 100 kHz to 20 MHz. In the exemplary embodiment, the oscillating unit 31 is recognized as an alternating-current power source generating the AC power.

The amplifying unit 32 increases the voltage of the high-frequency AC power to, for example, 10 V to 20 V. The voltage increasing unit 33 further increases the voltage to a high voltage of 1.5 kV, for example. Each of the amplifying unit 32 and the voltage increasing unit 33 can be realized by a winding transformer or a piezoelectric transformer, for example.

The electrode 34 is paired with the electrode 41, and they form an electric field coupling part in which the high-frequency AC power passes between the electrodes with the electric field coupling system. That is, since a capacitor is formed by the electrode 34 and the electrode 41 between which the cover 35 is interposed, alternating-current power passes therebetween by the action of the electrostatic induction upon application of an AC voltage to the capacitor. The electrode 34 and the electrode 41 do not contact with each other, and thus the wireless power supply is possible.

The cover 35 is disposed on one side of the electrode 34, which is the side toward the portable device 4, and insulates the electrode 34. The detailed description of the cover 35 will be given later.

The voltage of the high-frequency AC power received by the electrode 41 is 1.5 kV, for example. The voltage decreasing unit 42 decreases the voltage of the high-frequency AC power to around 30 V, for example. The voltage decreasing unit 42 is realized by a winding transformer or a piezoelectric transformer, for example.

The rectifying unit 43 converts, into DC power, the high-frequency AC power of which voltage has been decreased. The rectifying unit 43 is realized by a rectifying circuit and the like.

The converter 44 adjusts the voltage of the DC power to a voltage appropriate for the loading unit 45, and then the resultant power is transmitted to the loading unit 45. Thereby, a stable voltage and a stable current are usually supplied to the loading unit 45.

Note that only one electrode 34 is shown in FIG. 2, but plural electrodes are arranged in practice. The portable device 4 selects the most appropriate electrode 34 depending on the position of the portable device 4 put on the power supply table 3, and the wireless power supply starts by using the selected electrode 34.

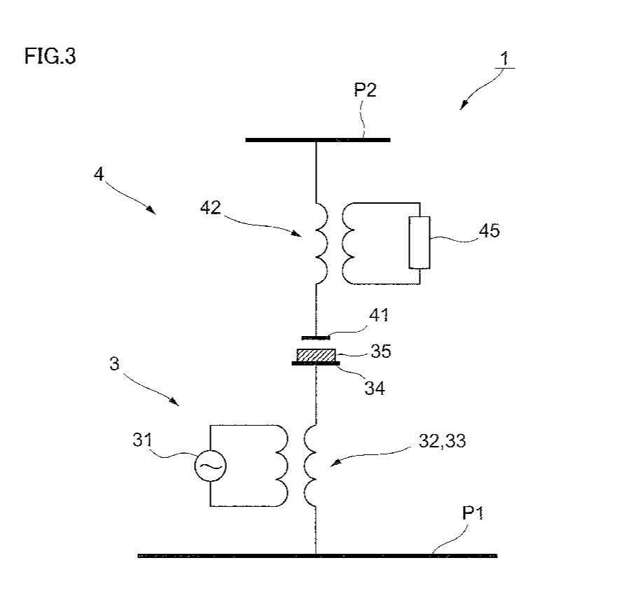

FIG. 3 is a conceptual diagram showing an operation principle of a series resonance configuration enabling the wireless power supply with the electric field coupling system.

As shown in the figure, the power supply system 1 of the exemplary embodiment has a structure in which two asymmetric dipoles are coupled in the vertical direction. That is, one dipole is formed by the electrode 34 as an active electrode and a passive electrode P1, and the other dipole is formed by the electrode 41 as an active electrode and a passive electrode P2. In this case, the passive electrode P1 is formed to be larger than the electrode 34 while the passive electrode P2 is formed to be larger than the electrode 41, so that the structure of each dipole becomes asymmetric. Further, the two asymmetric dipoles are coupled to each other in the vertical direction by causing the electrode 34 and the electrode 41 as the active electrodes to face each other. Further, the amplifying unit 32 and the voltage increasing unit 33 are disposed between the passive electrode P1 and the electrode 34, and the voltage decreasing unit 42 and the loading unit 45 are disposed between the electrode 41 and the passive electrode P2 in FIG. 3. Note that FIG. 3 illustrates the case where winding transformers are used as the amplifying unit 32, the voltage increasing unit 33, and the voltage decreasing unit 42, and the illustration of the rectifying unit 43 and the converter 44 is omitted for simplifying the description.

The passive electrodes P1 and P2 are actually the ground in FIG. 3. As described above, a high voltage of, for example, 1.5 kV is applied to the electrode 34 by using the voltage increasing unit 33. Due to the asymmetry of the dipole structure, a part between the electrode 34 and the electrode 41 is kept to have high voltage in comparison with the passive electrodes P1 and P2, and an induced electric field is concentrated in the part between the electrode 34 and the electrode 41. The AC power is transmitted due to the action of the electrostatic induction through the strong induced electric field.

The aforementioned electric field coupling system used in the power supply system 1 has following features.

(i) The portable device 4 has a high degree of positional freedom in the horizontal direction (free positioning).

There is an electromagnetic induction system using electromagnetic induction as one of the other systems for the wireless power supply. The electromagnetic induction system is a system in which power is transmitted between a power transmission coil and a power reception coil by using electromagnetic induction. In this case, even if the center axis of the power transmission coil and the center axis of the power reception coil are slightly misaligned, the power transmission efficiency is largely decreased. On the other hand, in the case of the electric field coupling system, since the electric field on the electrode 34 isotropically spreads, the formation of the induced electric field is rarely affected if the horizontal position of the electrode 34 and the horizontal position of the electrode 41 are slightly misaligned. Thus, the electric field coupling system has a higher degree of positional freedom in the horizontal direction than the electromagnetic induction system, and provides more convenience to the user using the portable device 4.

(ii) The shape and the material of each of the electrode 34 and the electrode 41 are less limited.

The high voltage is being applied to the electrode 34 and the electrode 41 forming the electric field coupling part, and thus a current passing between the electrode 34 and the electrode 41 is very small. Thus, it is unnecessary to use a good conductor such as silver or copper. Thus, a transparent electrode such as Indium Tin Oxide (ITO), or plating is usable, and the degree of freedom in design increases. Note that various kinds of metals, carbons, conductive polymers are usable for the electrode 34 and the electrode 41, and the material thereof is not particularly limited as long as it has conductivity. A thin electrode like a deposition film is accepted as each of the electrode 34 and the electrode 41, which has a high degree of freedom in shape, and thus weight increase of the portable device 4 is suppressed while integration to the portable device 4 is rarely affected.

(iii) Less heat is generated at the electric field coupling part.

Almost no current passes through the electric field coupling part, and the electrode 34 and the electrode 41 generate less heat. Thus, devices which are weak against heat, including a rechargeable battery, can be disposed in the vicinity of the electric field coupling part.

(iv) At intrusion of a foreign material, the foreign material is less heated.

Upon intrusion of a foreign material such as a metal in an area between the power transmission coil and the power reception coil, the foreign material is heated due to the action of the electromagnetic induction in the aforementioned electromagnetic induction system. On the other hand, even if a foreign material such as a metal intrudes into the electric field coupling part, heat of the foreign material hardly occurs.

Note that, in the aforementioned example that has been described in detail, the power supply system with the electric field coupling system using the series resonance circuit has been described. However, the power supply system is not limited to this, and may be a power supply system including a parallel resonance circuit as long as the electric field coupling system is used.

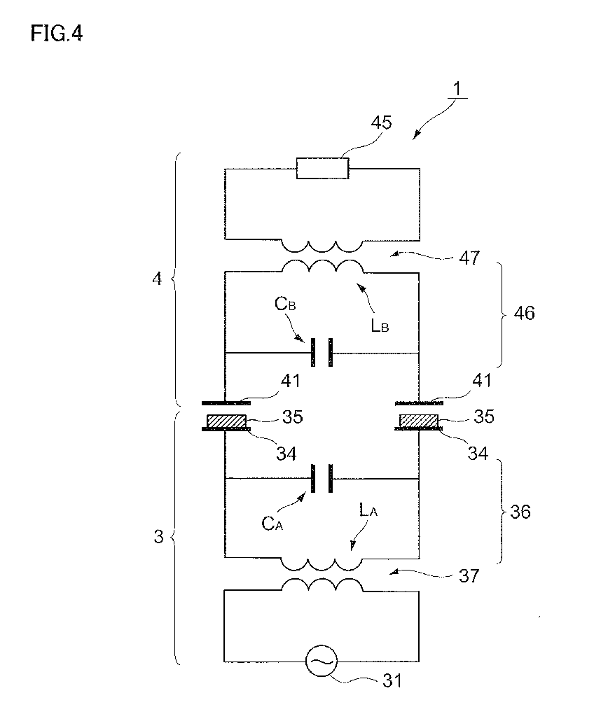

FIG. 4 is a diagram illustrating one example of a circuit conceptual diagram of a parallel resonance configuration.

In the circuit of the parallel resonance configuration, a coil L_{A} and a capacitor C_{A} at the power supply table 3 side are connected in parallel to form a parallel resonance circuit unit 36 as shown in the figure. Also, a coil L_{B} and a capacitor C_{B} at the portable device 4 side are connected in parallel to form a parallel resonance circuit unit 46. Note that the parallel resonance circuit unit 36 is connected to the oscillating unit 31 through a voltage changing unit 37 including the coil L_{A} as a part. Also, the parallel resonance circuit unit 46 is connected to the loading unit 45 through a voltage changing unit 47 including the coil L_{B} as a part.

In the circuit of the parallel resonance configuration, the electric field coupling part formed by the electrode 34 and the electrode 41 is excluded from part of the resonance circuit. Thus, if the junction capacitance varies, the effect on the resonance frequency is small, and the circuit with an extremely high impedance is achieved. Thus, there is a feature of a low supply voltage to the cover 35.

### <Description of Cover>

Next, the cover 35 will be described in detail.

In the circuit of the series resonance configuration, a high voltage is being applied to the electrode 34, as mentioned above. Thus, the surface of the electrode 34, which faces the electrode 41, is insulated to prevent users from getting electric shock or the like.

Therefore, the electrode 34 is covered with the cover 35 to insulate the surface of the electrode 34 which faces the electrode 41 in the exemplary embodiment.

The impedance between the electrode 34 and the electrode 41 is preferably lower. As the impedance is lower, the power transmission efficiency is more improved.

At this time, the impedance is defined by the equation (1) below.

$$\begin{matrix}[ Math 1 ] & \\ {X}_{c} = \frac{1}{2 π fC} & ( 1 )\end{matrix}$$

(Xc: Impedance, f: Frequency, C: Capacitance)

That is, as the frequency f of the AC current increases, the power transmission efficiency is more improved. Thus, the high frequency AC power is used in the exemplary embodiment.

Further, as the capacitance C is larger, the power transmission efficiency is more improved. Thus, the cover 35 located between the electrode 34 and the electrode 41 preferably has a larger capacitance.

Specifically, the cover 35 is required to ensure the insulation property and to have a larger capacitance.

In order to satisfy these two requirements, a power transmission sheet is used as the cover 35 in the exemplary embodiment. The power transmission sheet has a structure in which plural layers of a conductive sheet (a sheet of a conductive body) are stacked in the thickness direction in a dielectric body and the dielectric body is located between the plural layers, and different layers of the conductive sheet are electrically connected to each other. The power transmission sheet is recognized as one example of a power transmitter in the exemplary embodiment. A method for electrically connecting the conductive sheets includes a method in which a through-hole penetrating the different layers of the conductive sheet is formed to establish conduction, a method in which a corner of one side of each of plural conductive sheets is folded to make a contact with the other one of the plural conductive sheets, and a method in which the conductive sheet is used after being folded.

In the exemplary embodiment, a covering sheet in which a conductive sheet (a sheet of a conductive sheet) and a dielectric sheet (a sheet of a dielectric body) have been layered is prepared, and a power transmission sheet having a structure obtained by folding the covering sheet is preferably used as the cover 35 in view of easiness in production or the like.

The conductive sheet is not particularly limited as long as the material has conductive properties, and examples thereof include metals such as gold, silver, copper, and aluminum, conductive oxides such as Indium Tin Oxide (ITO), conductive polymers, conductive rubbers such as a conductive filler composite rubber, and the complexes or the like thereof. The form of the conductive sheet is appropriately chosen from a plate, a sheet, a film, or a membrane formed by sputtering, deposition, plating or the like according to the target thickness.

An example of the dielectric sheet is an insulation sheet having a capacitive component of, for example, a rubber or a resin, which includes adhesives, anchor coat agents, or the like. However, it is not particularly limited to the above example.

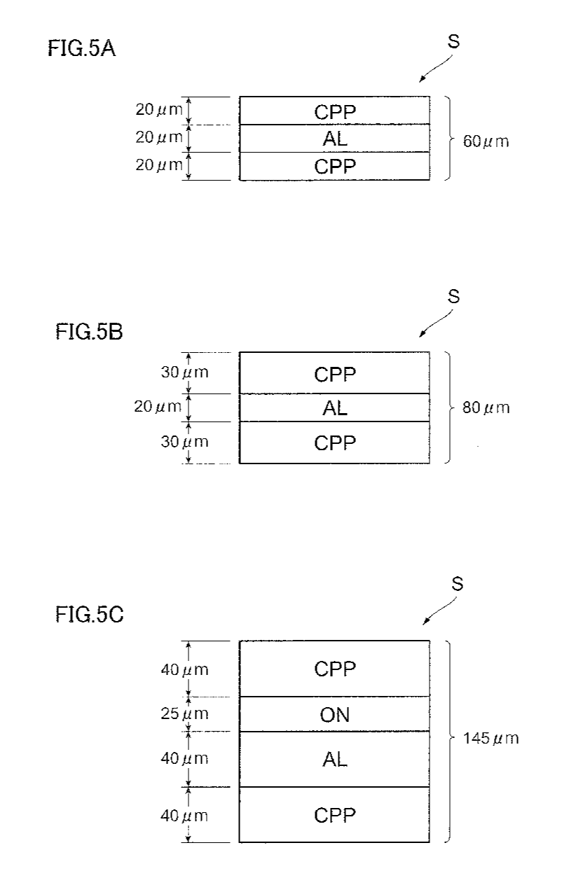

FIGS. 5A to 5C are diagrams illustrating examples of a covering sheet S.

In FIGS. 5A to 5C, an aluminum sheet (AL) is used as the conductive sheet. Further, a cast polypropylene (CPP) film or an oriented nylon (ON) film is used as the dielectric sheet.

An example of AL commercially available as the conductive sheet is a product name of A8P02H-On manufactured by Nippon Foil Mfg. Co., Ltd., an example of CPP as the dielectric sheet is a product name of allomer ET20C manufactured by Okamoto Industries, Inc., and an example of ON is a product name of BONYL (registered trademark) RX-F manufactured by KOHJIN Film & Chemicals Co., Ltd. However, the examples of these materials are not limited to the above.

Specifically, the covering sheet S in FIG. 5A is obtained by adhesively stacking the CPP (thickness of 20 μm), the AL (thickness of 20 μm), and the CPP (thickness of 20 μm) in this order by a dry lamination method, and the entire thickness is 60 μm.

The covering sheet S in FIG. 5B is obtained by stacking the CPP (thickness of 30 μm), the AL (thickness of 20 μm), and the CPP (thickness of 30 μm) in this order, and the entire thickness is 80 μm.

Further, the covering sheet S in FIG. 5C is obtained by stacking the CPP (thickness of 40 μm), the AL (thickness of 40 μm), the ON (thickness of 25 μm), and the CPP (thickness of 40 μm) in this order, and the entire thickness is 145 μm. Note that an adhesive layer is interposed between layers next to each other in the actual case although it is not shown in FIGS. 5A to 5C.

As described above, the covering sheet S of the exemplary embodiment has a structure in which the conductive sheet (AL) and the dielectric sheet (CPP, ON) have been layered. Further, each part between the conductive sheet and the dielectric sheet is preferably bonded by pressure bonding. The pressure bonding method is preferably thermocompression bonding performed by application of pressure and heat or bonding using an adhesive agent. Each of the conductive sheet and the dielectric sheet used at the pressure bonding may be a single sheet, or lamination of the conductive sheet and the dielectric sheet may be used. In the covering sheet S, the conductive sheet is preferably layered with the dielectric sheets to be held between the dielectric sheets, as shown in FIGS. 5A to 5C.

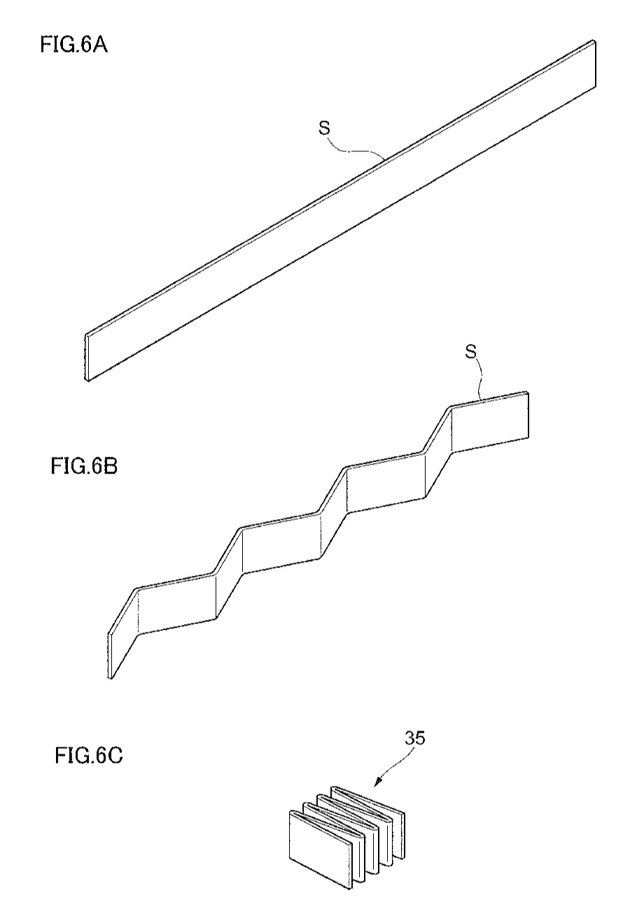

FIGS. 6A to 6C are views illustrating the first example of a method of folding the covering sheet S.

FIG. 6A illustrates a covering sheet S before the folding. The covering sheet S is a single sheet and is formed into a rectangle with a long width, as shown in the figure.

FIG. 6B is a view illustrating folding lines when the covering sheet S is folded.

In the folding method of the exemplary embodiment, mountain folds and valley folds are alternately arranged along the long side of the covering sheet S, as shown in the figure. In this case, the mountain folds and the valley folds are approximately parallel to the short side of the covering sheet S. That is, this case has the structure in which the single covering sheet S formed into the rectangle has been folded along the alternately-arranged mountain folds and the valley folds from one end part located to one short side toward the other end part. In other words, the structure has a zigzag shape, a bellows shape, or an accordion shape obtained by folding the single covering sheet S formed into the rectangle.

The cover 35 shown in FIG. 6C is prepared by folding the covering sheet S using the folding method.

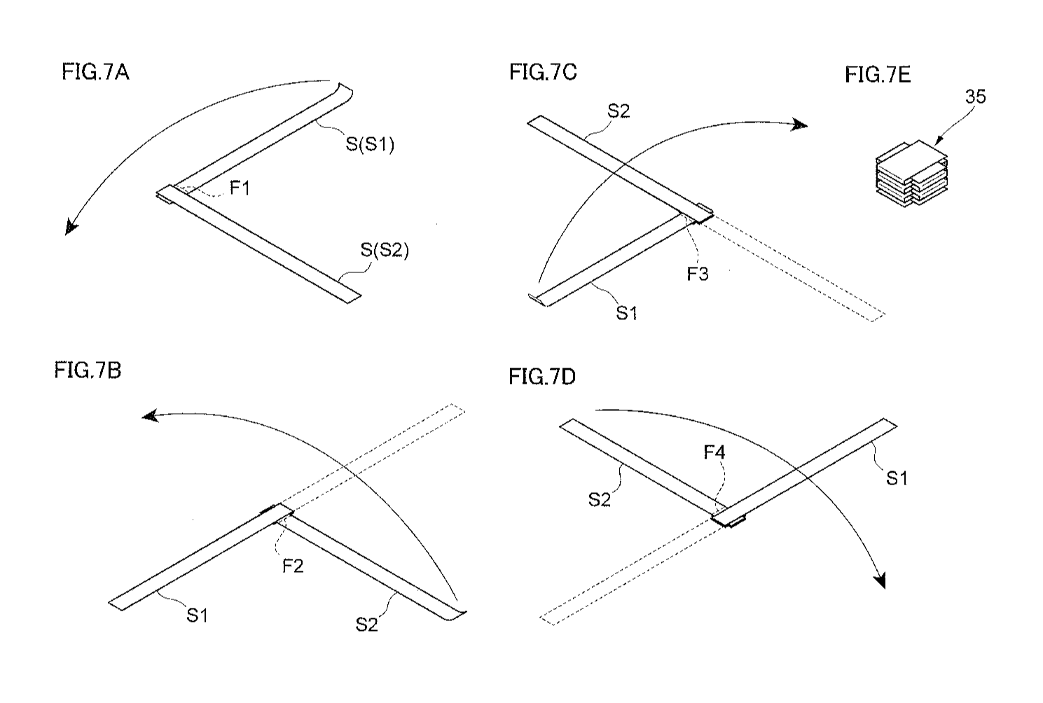

FIGS. 7A to 7E are views illustrating the second example of the method of folding the covering sheet S.

FIG. 7A shows the covering sheets S before the folding. The two covering sheets S are used as shown in the figure, and they are formed into rectangles of which long widths are approximately the same. Here, the covering sheets S are referred to as a covering sheet S1 and a covering sheet S2.

As shown in FIG. 7A, the two covering sheets S formed into the rectangles are overlapped so that one end part located to the short side of the one covering sheet S and one end part located to the short side of the other covering sheet S are orthogonally positioned. At this time, the one end part of the covering sheet S2 is placed on the one end part of the covering sheet S1.

Next, the other end of the covering sheet S1 is folded toward an arrow direction shown in the figure along a folding line F1 corresponding to a boundary between an area where the covering sheet S1 and the covering sheet S2 are layered and an area where the covering sheet S1 and the covering sheet S2 are not layered.

Thereby, the folded part of the covering sheet S1 is positioned on the upper part of the covering sheet S2, and the state in FIG. 7B is given.

Next, the other end of the covering sheet S2 is folded toward an arrow direction shown in the figure along a folding line F2 corresponding to a boundary between an area where the covering sheet S1 and the covering sheet S2 are layered and an area where the covering sheet S1 and the covering sheet S2 are not layered.

Thereby, the folded part of the covering sheet S2 is positioned on the upper part of the covering sheet S1, and the state in FIG. 7C is given.

Then, the other end of the covering sheet S1 is folded toward an arrow direction shown in the figure along a folding line F3 corresponding to a boundary between an area where the covering sheet S1 and the covering sheet S2 are layered and an area where the covering sheet S1 and the covering sheet S2 are not layered.

Thereby, the folded part of the covering sheet S1 is positioned on the upper part of the covering sheet S2, and the state in FIG. 7D is given.

Then, the other end of the covering sheet S2 is folded toward an arrow direction shown in the figure along a folding line F4 corresponding to a boundary between an area where the covering sheet S1 and the covering sheet S2 are layered and an area of the covering sheet S1 and the covering sheet S2 are not layered.

Thereby, the positional relationship between the covering sheet S1 and the covering sheet S2 comes into the state similarly to that in FIG. 7A, again.

Then, the operation in FIG. 7A to 7D are repeated. Thereby, after the folding of the covering sheet S1 and the covering sheet S2 is finished, the cover 35 shown in FIG. 7E is prepared.

As described above, the structure of the cover 35 described using FIGS. 7A to 7E may be rephrased as a folding structure in which the two covering sheets S have been alternately folded along the boundaries between the area where the two covering sheets are layered and the area where the two covering sheets are not layered.

The method of folding the covering sheet S is not limited to the above. The cover 35 can be prepared by various kinds of methods including a method in which one covering sheet S formed into an L shape is folded from the corner of the L shape so that the linear portions are alternately folded to be orthogonal each other and are stacked one another, for example. In any case, it is only necessary that the covering sheet S has a structure in which the conductive sheet is sandwiched between the dielectric sheets and these sheets are stacked.

The number of the stacked layers due to the folding of the covering sheet S is usually two or more, is preferably 2 to 50, and is more preferably 3 to 30, in view of reducing production cost or weight of the device and ensuring sufficient insulation properties of the electrode 34.

The thickness of the cover 35 having the structure in which the covering sheet S has been folded is usually 100 μm to 10 mm, is preferably 200 μm to 6 mm, and more preferably 300 μm to 5 mm. The thickness of the cover 35 less than 100 μm is not preferable in view of avoiding damage of the cover 35 and an electric shock due to the damage. In contrast, the thickness of the cover 35 larger than 10 mm is not preferable in view of the production cost and the like.

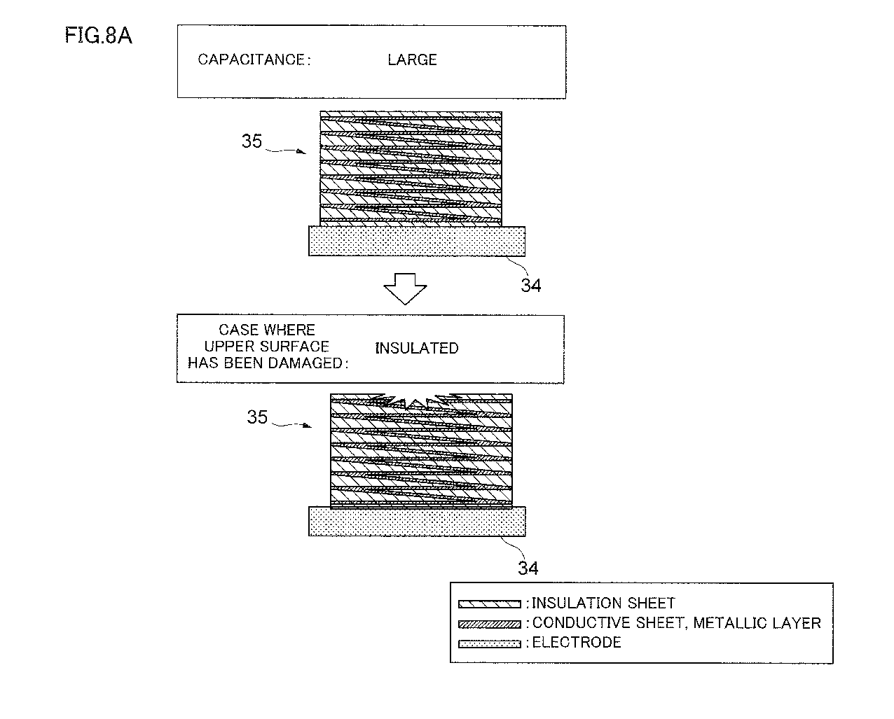

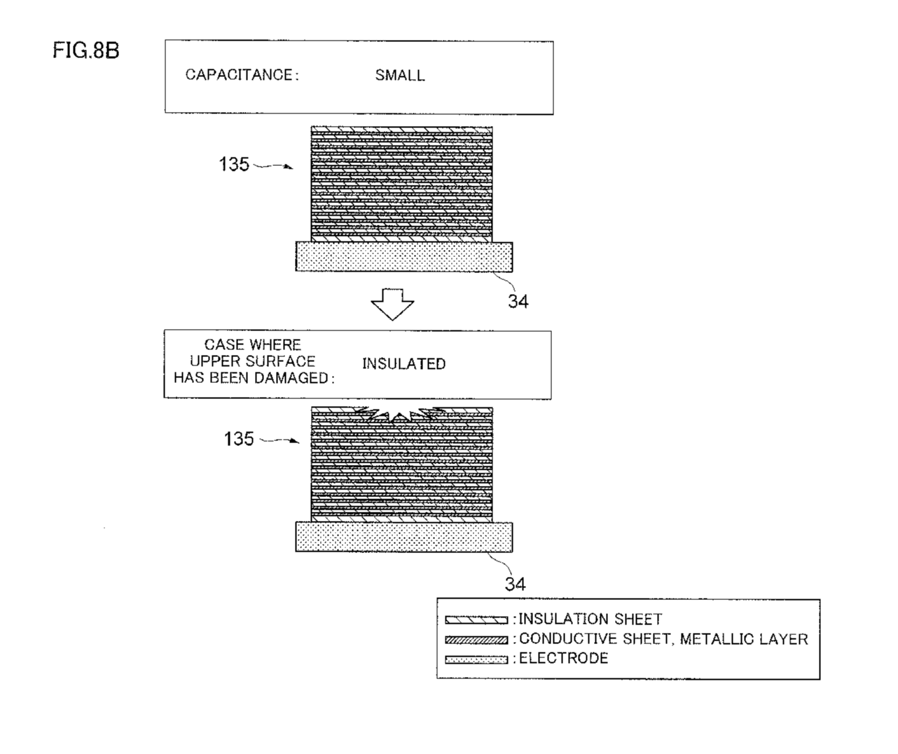

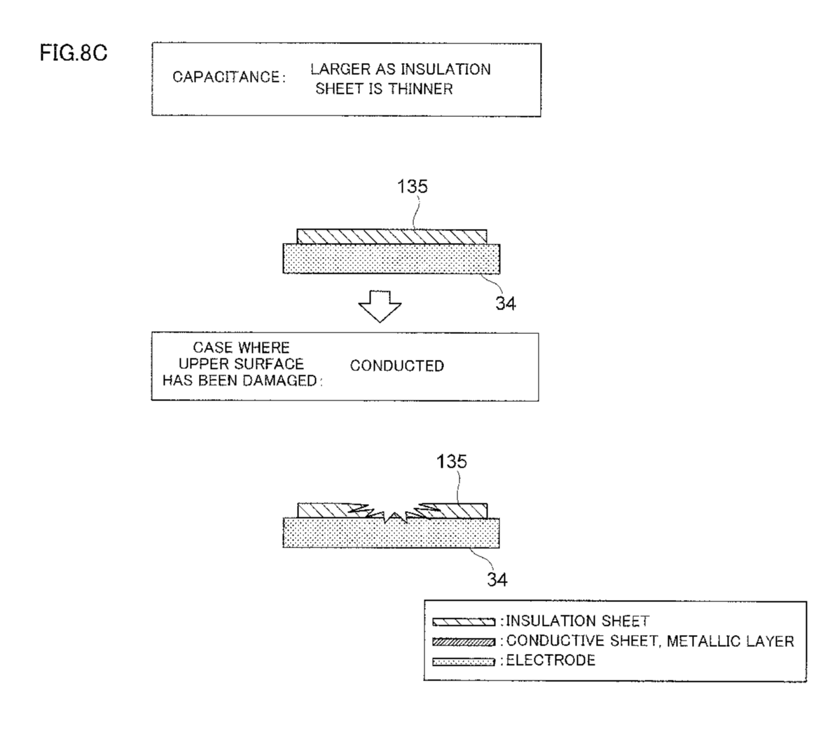

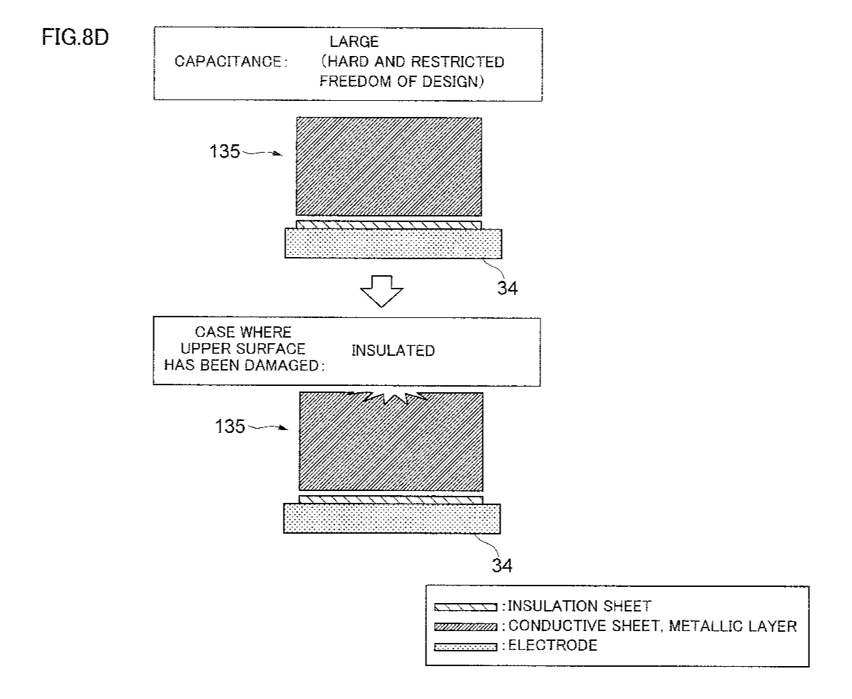

FIG. 8A is a diagram for describing the capacitance and the insulation properties of the cover 35 in the exemplary embodiment. FIGS. 8B to 8D are diagrams for describing the capacitances and the insulation properties of covers 135 according to other exemplary embodiments. The upper part of the diagram is an illustration for describing the capacitance, and the lower part of the diagram is an illustration for describing the insulation properties in the case where the upper surface of the cover is damaged, in each of FIGS. 8A to 8D.

FIG. 8A shows the cover 35 in the exemplary embodiment, and illustrates the folding state of the covering sheet S formed of the dielectric sheet and the conductive sheet.

FIG. 8B shows the case where the cover 135 has been prepared by alternately stacking individual dielectric sheets and the individual conductive sheets. That is, each one of the dielectric sheets is sandwiched between two of the conductive sheets, and vice versa. The dielectric sheets are not connected to each other and are independent, and the conductive sheets are not connected to each other and are independent.

Further, FIG. 8C shows the case where the cover 135 has been prepared by only using the dielectric sheet. Furthermore, FIG. 8D shows the case where the electrode 34 has been covered with a dielectric sheet, and a metallic layer has been formed above the dielectric sheet.

First, description will be given for difference in capacitance between the configurations of the covers by using the upper parts of the diagrams of FIGS. 8A to 8D.

The capacitance of the cover (that is, junction capacitance between the electrode 34 and the electrode 41) is junction capacitance formed by the electrode 34, the electrode 41, and the cover, for transmitting or receiving power using the electric field coupling system. Specifically, it is determined according to the capacitance of the dielectric sheet being in contact with the electrode 34 and/or the electrode 41. The capacitance of the dielectric sheet is larger as the dielectric sheet is thinner. From this standpoint, the capacitances of the covers shown in the upper parts of the diagrams of FIGS. 8A to 8D will be evaluated.

First, the capacitance of the dielectric sheet being in contact with the electrode 34 or the capacitance of the dielectric sheet placed on the portable device 4 side (being in contact with the electrode 41) is related to the junction capacitance between the electrode 34 and the electrode 41, in the cover 35 in FIG. 8A. The thickness of each dielectric sheet is, for example, 20 μm to 65 μm, as described above. Thus, even if the sheet is folded to form many layers, the junction capacitance is not largely decreased since the junction capacitance is approximately determined according to the capacitances of the outermost two dielectric sheets.

Next, in the cover 135 in FIG. 8B, the thickness of the dielectric sheet being in contact with the electrode 34 and the thickness of the dielectric sheet placed on the portable device 4 side can be set to be the same as those in FIG. 8A. However, since the conductive sheets are individually stacked in this case, serial capacitors are formed by the conductive sheets. In this case, if the number of the stacked dielectric sheets is set at n and the respective capacitances are set at C₁, C₂, C₃, . . . Cₙ₋₁, and Cₙ, the junction capacitance C of the cover 135 in FIG. 8B is expressed by the following equation (2).

$$\begin{matrix}[ Math 2 ] & \\ C = \frac{1}{{\sum }_{k = 1}^{n} ( 1 / {C}_{k} )} & ( 2 )\end{matrix}$$

(C: Junction capacitance, Cₖ: Capacitance of each dielectric sheet)

In other words, the junction capacitance C is markedly decreased as the number of the stacked layers is increased in the case of FIG. 8B.

In the cover 135 in each of FIGS. 8C and 8D, the junction capacity can be increased if the thickness of the dielectric sheet is formed to be thin like the dielectric sheet shown in FIG. 8A.

Next, description will be given for the difference in insulation properties between the configurations of the covers in the case where the upper surface of each cover has been damaged, using the lower parts of the diagrams of the FIGS. 8A to 8D.

First, the cover 35 in FIG. 8A has a multilayer structure of the covering sheet obtained by folding the covering sheet, and the entire thickness becomes large. Thus, even in the case where the upper surface of the cover 35 has been damaged, the electrode 34 is rarely affected. Thus, the cover 35 is recognized to have a configuration easily ensuring the insulation properties of the electrode 34.

The same is true for the case of FIG. 8B. That is, FIG. 8B also has a configuration easily ensuring the insulation properties of the electrode 34.

On the other hand, if the thickness of the dielectric sheet forming the cover 135 is formed to be thin in order to increase the junction capacitance as in the case of FIG. 8C, the electrode 34 is easily exposed in the case where the upper surface of the cover 135 has been damaged. Thus, the cover 135 in FIG. 8C is recognized to have a configuration having difficulty in ensuring the insulation properties of the electrode 34.

In the case of FIG. 8D, the metallic layer is located above the dielectric sheet although the dielectric sheet is formed to be thin in order to increase the junction capacity. Thus, even in the case where the upper surface of the cover 135 has been damaged, the insulation properties of the electrode 34 are easily ensured. However, in the case where the thickness of the metallic layer is increased to ensure the insulation properties, the cover 135 as a whole is hard and the flexibility thereof is lost, and thus freedom of the design is restricted.

In summary, it is the cover 35 in FIG. 8A that has the configuration of the cover ensuring the insulation properties, having a large junction capacitance, and being excellent in flexibility and the like.

### <Description of the Method for Producing the Cover>

Next, the description will be given for the method for producing the cover 35.

First, the covering sheet S is prepared by putting the conductive sheet and the dielectric sheet together and layering the conductive sheet and the dielectric sheet (covering sheet preparation process).

At this time, it is preferable to include a process in which the conductive sheet and the dielectric sheet are stacked and are unified. The method of unifying the conductive sheet and the dielectric sheet is not particularly limited. However, the method preferably includes a process of thermocompression bonding (thermocompression bonding process) or a process of adhesion using an adhesive agent (adhesion process). The thermocompression bonding may be performed by thermal pressurization, pressing an iron, or causing the covering sheet S to pass between a pair of rollers having a heater or the like at the inside thereof. The adhesion using an adhesive agent may be performed by a dry lamination method.

Thereby, the covering sheet S like the examples described in FIGS. 5A to 5C can be prepared.

Next, the covering sheet S prepared in the covering sheet preparation process is folded (folding process). For example, the method described in FIGS. 6A to 6C or FIGS. 7A to 7E can be applied as the folding method. However, the folding method is not limited to the above. Incidentally, by using the method described in each of FIGS. 6A to 6C and FIGS. 7A to 7E, the thickness of the cover 35 can be easily increased, and the cover 35 having excellent insulation properties can be prepared.

The production of the cover 35 can be performed as described above.

Note that, in the example described above in detail, the cover 35 has been disposed on the electrode 34. However, the position of the cover 35 is not limited to this. The cover 35 may be disposed on the electrode 41 side, or each of the electrode 34 side and the electrode 41 side.

### Example

Hereinafter, this invention will be described in detail using an example. However, this invention is not limited to the example, within the gist of this invention.

### [Preparation of the Cover]

The three covering sheets S shown in FIGS. 5A to 5C were prepared. The capacitance and the dielectric tangent (tan δ) were measured as electric characteristics of each single piece of these covering sheets S. At this time, a precision impedance analyzer 4294A manufactured by Agilent Technologies was used. The measurement frequency of 6.78 MHz was used.

### Example

Next, each covering sheet S was folded by the method described in FIGS. 6A to 6C, and each cover 35 of 5 cm square was prepared, as the example. At this time, the number of the stacked layers of the covering sheet S was changed, and the capacitance and the dielectric tangent (tan δ) were measured for each number.

### Comparative Example

Each of the three covering sheets S shown in FIGS. 5A to 5C was cut, and then the cut pieces were stacked like FIG. 8B, and each cover 135 of 5 cm square was prepared. At this time, the number of the stacked layers of the covering sheet S was changed, and the capacitance and the dielectric tangent (tan δ) were measured for each number, similarly to the example.

### [Measured Result]

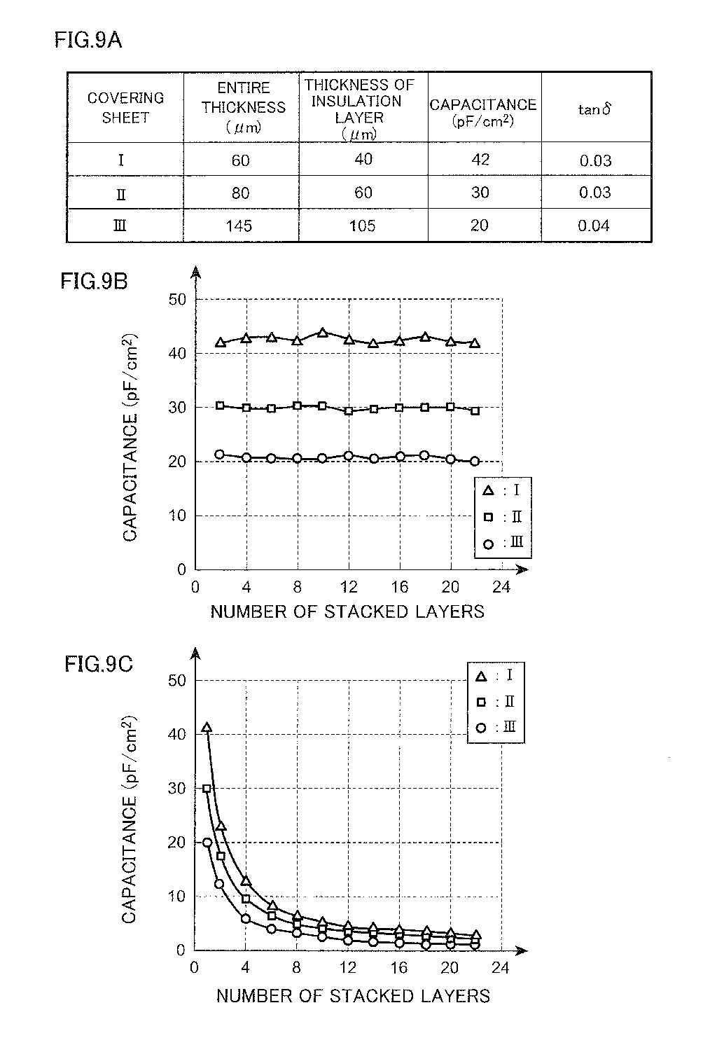

The measured result is shown in FIGS. 9A to 9C.

FIG. 9A shows the electric characteristics of each single piece of the three covering sheets S shown in FIGS. 5A to 5C before the stacking by the fold or the like.

At the column of the covering sheet, (I) denotes the covering sheet shown in FIG. 5A. Similarly, (II) denotes the covering sheet shown in FIG. 5B, and (III) denotes the covering sheet shown in FIG. 5C. As the electric characteristics of each single covering sheet S, (I) has the value of 42 pF/cm², (II) has the value of 30 pF/cm², and (III) has the value of 20 pF/cm². The result shows the capacitance, which is the junction capacitance in other words, increases as the thickness of the dielectric sheet being in contact with the electrode 34 is thinner.

FIG. 9B is a graph showing change of the capacitance as the number of the stacked layers of the covering sheet S is changed in the example. That is, FIG. 9B shows the change of the junction capacity in the case where the cover 35 has been prepared by folding the covering sheet S.

Further, FIG. 9C is a graph showing the change of the capacitance as the number of the stacked layers of the covering sheet S is changed in the comparative example. That is, FIG. 9C shows the change of the junction capacity in the case where the cover 135 has been prepared by cutting the covering sheet S and stacking the cut pieces.

Note that, in FIGS. 9B and 9C, the horizontal axis represents the number of the stacked layers of the covering sheet S and the vertical axis represents the capacitance, that is, the junction capacitance.

As shown in FIG. 9B, the capacitance remained substantially unchanged while the number of the stacked layers was changed in the example.

Meanwhile, as shown in FIG. 9C, the capacitance decreased in response to the increase of the number of the stacked layers in the comparative example.

Note that the tan δ remained substantially unchanged while the number of the stacked layers was changed in the cases of FIG. 9B and FIG. 9C.

### REFERENCE SIGNS LIST

1 . . . Power supply system
2 . . . AC adapter
3 . . . Power supply table
4 . . . Portable device
30 . . . Power supply module
31 . . . Oscillating unit
32 . . . Amplifying unit
33 . . . Voltage increasing unit
34, 41 . . . Electrode
35 . . . Cover
36, 46 . . . Parallel resonance circuit unit
37, 47 . . . Voltage changing unit
40 . . . Power receiving module
42 . . . Voltage decreasing unit
43 . . . Rectifying unit
44 . . . Converter
45 . . . Loading unit
S . . . Covering sheet

1. A power transmitter used for wireless power supply, comprising:
a dielectric body;
a sheet of a conductive body forming, in the dielectric body, a plurality of layers stacked in a thickness direction; and
a structure in which the dielectric body is also located between the plurality of layers is formed, wherein
different layers of the sheet of the conductive body are electrically connected.

2. The power transmitter according to claim 1, wherein
a structure in which the sheet of the conductive body has been folded in the dielectric body.

3. The power transmitter according to claim 2, wherein
a structure in which a covering sheet has been folded, the covering sheet being formed by putting the sheet of the conductive body and a sheet of the dielectric body together, and layering the sheet of the conductive body and the sheet of the dielectric body.

4. The power transmitter according to claim 3, wherein
a structure in which the covering sheet formed into a rectangle has been alternately mountain-folded and valley-folded from one short side toward the other short side.

5. The power transmitter according to claim 3, wherein
a structure in which the one covering sheet formed into a rectangle and the another covering sheet formed into a rectangle have been folded by orthogonally arranging and layering one short side of the one covering sheet and one short side of the another covering sheet, and alternately folding the one covering sheet and the another covering sheet along lines each corresponding to a boundary between an area where the one covering sheet and the another covering sheet are layered and an area where the one covering sheet and the another covering sheet are not layered.

6. The power transmitter according to claim 1, wherein
the wireless power supply is performed by an electric field coupling system.

7. The power transmitter according to claim 1, wherein
the dielectric body is made of any one of a rubber and a resin.

8. The power transmitter according to claim 1, wherein
the conductive body is made of at least one chosen from among metals, conductive oxides, conductive polymers, conductive filler composite rubbers and complexes thereof.

9. A power supply device comprising:
an alternating-current power source generating an alternating-current power;
an electrode forming an electric field coupling part for supplying the alternating-current power to a power consumption device by an electric field coupling system, the power consumption device consuming the alternating-current power generated by the alternating-current power source; and
a cover disposed on one side of the electrode, and insulating the electrode, the one side being a side toward the power consumption device, wherein
the cover is the power transmitter according to claim 1.

10. A power consumption device comprising:
an electrode forming an electric field coupling part for receiving, by an electric field coupling system, an alternating-current power from a power supply device supplying the alternating-current power;
a loading unit consuming the alternating-current power received by the electrode; and
a cover disposed on one side of the electrode, and insulating the electrode, the one side being a side toward the power supply device, wherein
the cover is the power transmitter according to claim 1.

11. A power supply system comprising:
an alternating-current power source generating an alternating-current power;
a loading unit consuming the alternating-current power generated by the alternating-current power source;
an electric field coupling part comprising a pair of electrodes facing together, and allowing the alternating-current power to pass between the electrodes as the pair using an electric field coupling system; and
a cover disposed between the electrodes as the pair, and insulating at least any one of the electrodes as the pair, wherein
the cover is the power transmitter according to claim 1.

12. A method for producing the power transmitter according to claim 3, the method comprising:
preparing the covering sheet by putting the sheet of the conductive body and the sheet of the dielectric body together and layering the sheet of the conductive body and the sheet of the dielectric body; and
folding the covering sheet that has been prepared.

13. The method for producing the power transmitter according to claim 12, wherein
preparing the covering sheet includes unifying the sheet of the conductive body and the sheet of the dielectric body.

14. The method for producing the power transmitter according to claim 13, wherein
unifying the sheet of the conductive body and the sheet of the dielectric body is performed by thermally bonding the sheet of the conductive body and the sheet of the dielectric body with pressure.

15. The method for producing the power transmitter according to claim 13, wherein
unifying the sheet of the conductive body and the sheet of the dielectric body is performed by adhering the sheet of the conductive body and the sheet of the dielectric body with an adhesive agent.
